(19) United States
(12) Patent Application Publication
(10) Pub. No.: US 2008/0137905 A1
(43) Pub. Date: Jun. 12, 2008

(54) Method and Device for Inserting Data in Fixed or Animated Images

(76) Inventor: Stephane Madrange, Saint Germain en Laye (FR)

Correspondence Address: BACHMAN & LAPOINTE, P.C., 900 CHAPEL STREET, SUITE 1201, NEW HAVEN, CT, 06510, US

(21) Appl. No.: 11/662,290

(22) PCT Filed: Sep. 6, 2005
(86) PCT No.: PCT/FR2005/002213

§ 371 Date: Jan. 9, 2008

(30) Foreign Application Priority Data
Sep. 8, 2004 (FR) 0409521

(51) Int. Cl. G06K 9/00

(52) U.S. Cl. 382/100

(57) ABSTRACT

A method for inserting data, including a predetermined number of symbols, into an image sequence of at least one image comprising a predetermined number of lines each containing a predetermined number of pixels, comprising the steps of generating a set of functions with a comb-shaped spectrum inserted in an image sequence spectrum and including a respective function for each symbol of the information to be inserted, phase shifting each function of the set of functions by a value representing a respective symbol of the data to be inserted, superimposing the phase-shifted functions, and combining the pixels of the image sequence with a result obtained by superimposing phase-shifted functions.

### BACKGROUND

This invention relates to the insertion of data in fixed or animated images.

It applies in particular, but not exclusively, to the creation and insertion of watermarks in an image or an image sequence, the insertion of data for the purpose of indexing the images of a sequence, or the scrambling of video images. In applications for inserting watermarks and indexing images, the insertion of information must be performed so that it is imperceptible. By contrast, in image scrambling applications, this insertion must significantly impair the quality of the images.

The techniques for digitisation of content such as fixed or animated images makes it possible to produce copies of this content in unlimited amounts and without impairment of the quality. Simultaneously, the development of computer networks and personal computers results in an uncontrolled dissemination of this content. It therefore becomes increasingly difficult to ensure compliance with the copyrights to this content.

There are protection techniques making it possible to monitor this dissemination of copyright-protected works, which can be classified into two categories. The first category combines the cryptographic techniques that consist of applying an encryption to the digitised content making it unreadable without a decryption key. The second category combines the techniques for inserting non-perceptible watermarks containing data making it possible to identify a legal copy of a work, or a code limiting the possibilities of duplication.

For a watermark insertion technique to be effective, the watermarks must not be capable of being removed from the content without substantial damage to the image quality. In particular, it must be impossible remove the watermarks by combining a plurality of copies of the same content. In addition, images and in particular video sequences commonly undergo numerous processing operations such as digital-to-analogue and analogue-to-digital conversions, compression/decompression processing, or processing operations for modifying scale, cropping, light adjustment, contrast and colours. The watermarks must also be resistant to these processing operations.

The technique used must also make it possible to insert an adequate amount of information, considering that the more this amount is increased, the more the watermark insertion will affect the image quality, and therefore the strength of the watermark.

There are numerous techniques for inserting watermarks in fixed or animated images, which are more or less resistant to attacks and image processing operations. Among these techniques, the patent U.S. Pat. No. 6,557,103 describes a steganography method causing a preliminary modulation of the message to be inserted into images by a spread spectrum sequence. By comparison with the other watermark insertion techniques, this method has good performance in terms of strength and bandwidth for the information inserted in the image.

However, this method, while generic, is not optimal in the case of images, and requires preliminary encoding of the message to be inserted into the image, using encoding with error correction, which contributes to a reduction bandwidth or the amount of useful data capable of being inserted into the image.

### SUMMARY OF THE INVENTION

This invention is intended to overcome this disadvantage. This objective is achieved by providing a method for inserting data including a predetermined number of symbols in an image sequence of at least one image comprising a predetermined number of lines each containing a predetermined number of pixels.

According to the invention, this method includes steps consisting of:

generating a set of functions with a comb-shaped spectrum inserted in the image sequence spectrum, and including a respective function for each symbol of the information to be inserted,

phase shifting each function of the set of functions by a value representing a respective symbol of the data to be inserted,

superimposing the phase-shifted functions, and

combining the pixels of the image sequence with the result obtained by superimposing phase-shifted functions.

According to a preferred embodiment of the invention, this method also includes a step of interleaving data symbols to be inserted, prior to the phase shifting of each function of the set of functions.

According to a preferred embodiment of the invention, this method includes, prior to the modulation phase shifting of each function of the set of functions, steps of generating a pseudo-random sequence including a respective symbol for each data symbol to be inserted, and of shuffling data symbols to be inserted with the pseudo-random sequence.

The shuffling step preferably consists of combining, in an exclusive OR operation, data symbols to be inserted and the pseudo-random sequence.

According to a preferred embodiment of the invention, the functions of the function set have respective main spectral lines spaced apart by a constant step corresponding to the line frequency of the image sequence.

According to a preferred embodiment of the invention, the image sequence has a comb-shaped spectrum, the comb-shaped spectrum of the function set being phase shifted with respect to the spectrum of the image sequence of a frequency that is adjusted.

According to a preferred embodiment of the invention, the combination of pixels of the image sequence with the result of the superimposing of phase-shifted functions is performed by modulating the brightness of the pixels of the image sequence.

According to a preferred embodiment of the invention, the combination of the pixels of the image sequence with the result of the superimposing of the phase-shifted functions is performed by rotating the colour components of the pixels of the image sequence.

According to a preferred embodiment of the invention, this method also includes a step of pre-processing the image so as to avoid saturation phenomena in the pixels of the image sequence when they are combined with the result of the superimposing of phase-shifted functions.

According to a preferred embodiment of the invention, this method also includes a step of coding data symbols to be inserted, so as to obtain a sequence of distinct symbols for each colour component of the pixels of the image sequence, the functions of the function set being phase shifted by each of the sequences of symbols obtained, superimposed, then combined respectively with the colour components of the pixels of the image sequence.

According to a preferred embodiment of the invention, the coding applied to the data symbols to be inserted, in order to obtain a distinct symbol sequence for each colour component, is a convolutional-type-coding.

According to a preferred embodiment of the invention, the combination of pixels of the image sequence with the result of the superimposing of the phase-shifted functions is performed so as to be relatively invisible in the image sequence.

According to a preferred embodiment of the invention, the combination of pixels of the image sequence with the result of the superimposing of the phase-shifted functions is performed so as to scramble the images in the image sequence.

The invention also relates to a method for extracting data from an image sequence of at least one image comprising a predetermined number of lines each containing a predetermined number of pixels. According to the invention, the data has been inserted according to the insertion method defined above.

The invention also relates to a method for descrambling an image sequence of at least one image comprising a predetermined number of lines each containing a predetermined number of pixels. According to the invention, the image sequence has been scrambled according to the insertion method defined above.

The invention also relates to a device for inserting data including a predetermined number of symbols, in an image sequence of at least one image comprising a predetermined number of lines each containing a predetermined number of pixels. According to the invention, this device includes means for implementing the data insertion method defined above.

The invention also relates to a device for extracting data from an image sequence of at least one image comprising a predetermined number of lines each containing a predetermined number of pixels. According to the invention, this device includes means for implementing the data extraction method defined above.

The invention also relates to a device for descrambling an image sequence of at least one image comprising a predetermined number of lines each containing a predetermined number of pixels. According to the invention, this device includes means for implementing the image descrambling method defined above.

### BRIEF DESCRIPTION OF THE DRAWINGS

A preferred embodiment of the invention will be described below, by way of a non-limiting example, with reference to the appended drawings, in which:

FIG. 1 shows the spectrum of a video image sequence;

FIG. 2 diagrammatically shows a device according to the invention for inserting information into a fixed image or an image series;

FIG. 3 diagrammatically shows a device according to the invention for extracting information inserted into a fixed image or an image series, using the device shown in FIG. 2;

FIG. 4 diagrammatically shows a device according to the invention for restoring broken up images using the device shown in FIG. 2;

FIG. 5 diagrammatically shows an alternative of the device shown in FIG. 2;

FIG. 6 diagrammatically shows a device according to the invention for extracting information inserted into a fixed image or an image series, using the device shown in FIG. 5;

FIG. 7 diagrammatically shows a device according to the invention for restoring broken up images using the device shown in FIG. 5.

### DETAILED DESCRIPTION OF THE PREFERRED EMBODIMENT(S)

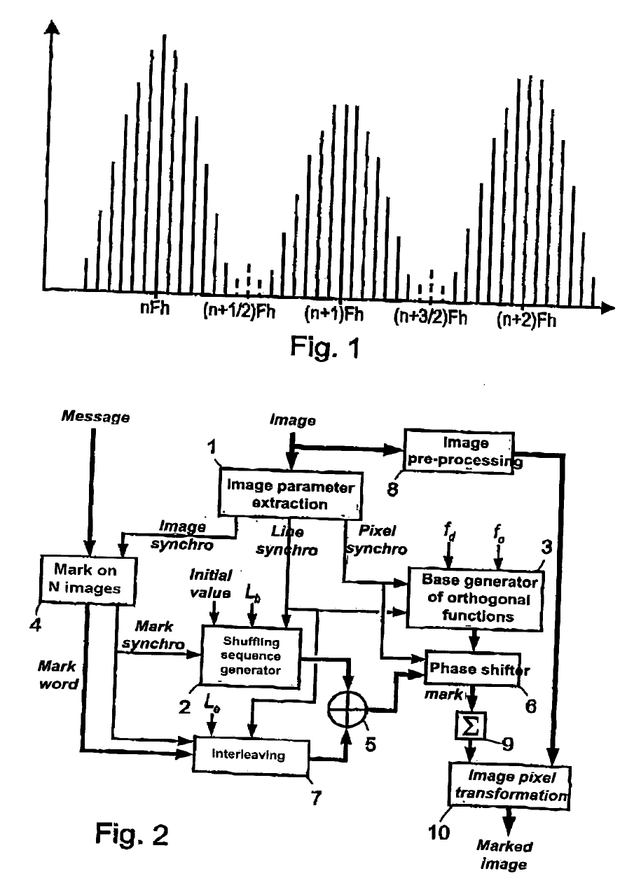

This invention is based on the use of the spectral form of a baseband digital image or image series (unmodulated) as shown in FIG. 1. In this figure, it can be noted that the energy of the spectrum of an image series is distributed in sets of lines spaced apart by the image frequency, each set of lines having a maximum energy at a multiple frequency n.f_{H} of the line frequency f_{H} of the lines of the image. Two consecutive energy maximums are therefore spaced apart by the line frequency f_{H} (H for horizontal).

This invention proposes using the intervals of the spectrum between the energy peaks corresponding to multiples of the line frequency f_{H} in order to insert data forming a mark therein. It is also possible to envisage inserting data between the lines spaced apart by the image frequency.

FIG. 1 shows a device according to the invention for inserting a mark in an image or image series. This device includes a module 1 for extracting parameters of the image producing synchronisation signals making it possible to locate the lines and the pixels in the image, and, if it is an image series, the images of the sequence.

The synchronisation signals at the line and pixel frequency are applied to a function generator 3, said functions having the special feature of being mutually orthogonal, the orthogonality being defined in this case in the direction of the scalar product of the functions. In addition, they must form an orthogonal base in the vector space of the functions so as to form a comb spectrum inserted in the image spectrum as shown in FIG. 1. The number of functions is variable and related to the number of symbols constituting the message to be inserted into the image. In the example of FIG. 1, the orthogonal functions used are sinusoidal functions of which the respective frequencies are spaced apart by the line frequency f_{H} and frequency phase shifted by a certain step, for example, equal to f_{H}/2 with respect to the maximum energy at the frequencies n.f_{H} of the image. Such orthogonal functions have the form:

sin(kωt),

in which k is an integer varying between 1 and K, which is parameterisable, ω=2π(f_{H}+f_{d}), and f_{d} is a phase-shifted frequency of the sinusoidal function equal to a fraction of the line frequency f_{H}. There is advantageously a fine adjustment of the frequency position of each orthogonal function forming the comb in the interval [n.f_{H}, (n+1).f_{H}], i.e. the phase-shifted frequency f_{d}, so as to optimise the strength and visibility of the mark in the image. Tests easily show that an optimum condition is obtained with f_{d}=0.9 f_{H}.

It is also possible to apply a phase shift at a frequency f₀ equal to an integer times the line frequency f_{H} so as to adjust the frequency position of the entire comb formed by the set of orthogonal functions with respect to the image spectrum. It is thus sometimes preferable to phase shift the comb of the orthogonal functions toward high frequencies where the message inserted in the image will be less disrupted by the image signals.

These adjustments make it possible to obtain a condition of quasi-orthogonality with respect to the image spectrum. Nevertheless, this condition is not always required. Indeed, if the image is to be scrambled, this fine phase shifting can be used to suppress the orthogonality between the comb and the image spectrum.

It is possible to envisage using other functions such as wavelet functions, such as Haar or Hadamard functions, or windowed sinusoids. Such functions have the form:

Re[exp(jkω_{H}t)]×F(t)

where Re(c) is the real part of the complex number c, and F(t) is a periodic windowing function such as a Hanning, Hamming or Blackmann function or a raised cosine or a truncated Gaussian function, or a wavelet function such as a Haar function.

The set of orthogonal functions produced by the generator 3 is, for example, generated in the form of a software table or an indexed storage.

It is also possible to envisage orthogonal functions spaced apart not by the line frequency f_{H}, but by the image frequency, which is in general several dozen Hertz.

In addition, the message to be inserted into the image or the image sequence is processed by a module 4 that completes the message with start-of-mark and end-of-mark signals, and, in the case of an image sequence, which performs a distribution of the message in N successive images, by copying or cutting the message.

Each part of the message to be inserted into each image can be processed by an interleaving module 7 that carries out a permutation of the bits of the part of the message. The interleaving makes it possible to distribute, in a balanced manner, the symbols of the message over the basic functions. The interleaving is performed over a period equivalent to a certain number Lₑ of lines. Every Lₑ lines, the permutation law is modified.

The device shown in FIG. 2 can also include a module for generating a pseudorandom sequence used as a shuffling sequence based on an initial value and the line synchronisation signal, received at the input.

The shuffling sequence generated is combined with the message at the output of the module 4 or 7 by an exclusive OR operation 5 producing the basic symbols of the message.

The processing of the message by a shuffling sequence makes it possible to prevent redundancies visible to the eye or by electronic means. The shuffling is performed over a period equivalent to a certain number L_{b} of lines. Every L_{b} lines, the shuffling law is modified.

The basic symbols of the message at the output of the operation 5 are applied to a phase shifter 6 also receiving, at the input, all of the basic functions produced by the generator 3. The phase shifter 6 uses each of the basic symbols of the message, from the operation 5 in order to determine a phase at the origin of each of the basic functions. In the case of a base of sinusoidal functions, this amounts to applying, to each of the functions, a BPSK (Binary Phase-Shift Keying) phase modulation, of which the rhythm is dependent on the parameters Lₑ, L_{b} and a synchronisation signal associated with the message. It is easy to extend this principle to QPSK (Quadrature Phase-Shift Keying) or QAM (Quadrature Amplitude Modulation) modulations, or even to GMSK (Gaussian Minimum-Shift Keying) non-linear modulations, for example.

The phase-shifted functions generated by the phase shifter 6 are superimposed or added by a summer 9, so as to obtain a resulting function which is then sampled, then mixed with the image by a module 10 for transforming the image applying, to the pixels of the image, a transformation depending on a respective sample of the resulting function.

The transformation applied to the pixels of the image can be, for example, a modification of the brightness by adding samples of the resulting function obtained by the phase shifter or a rotation of the colour components of the image, or any other operation on the basic components of the pixels. According to the application of the invention to the insertion of watermarks or to the scrambling of images, the amplitude of the transformation will be chosen to be more or less high.

In the case of the insertion of watermarks, it is possible to apply a pre-processing operation 8 to the image before its transformation, so as to reduce the variation dynamic of the pixel values, in order to prevent saturation when the mark is inserted by the transformation module 10. Thus, if each colour component of the pixels is coded from 0 to 255 (on 8 bits), this pre-processing can consist of converting the values of the pixel components so that they are between 16 and 235, for example.

The parameters Lₑ and L_{b} preferably correspond to an integer of symbols in the mark to be inserted into the image. However, in the opposite case, it is possible to complete each line of the image with a specific symbol or to repeat the last symbol of the mark until the end of the line.

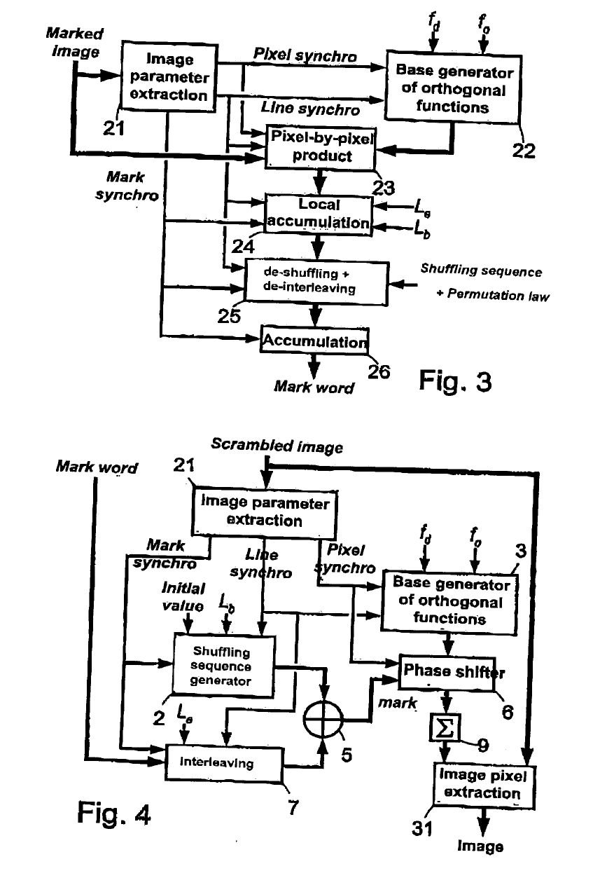

FIG. 3 shows a device making it possible to extract a mark from an image or an image sequence. This device includes a module 21 for extracting parameters from the image producing, from the marked image, synchronisation signals, making it possible to locate the lines and the pixels of the image, as well as the start and end marks of the inserted message, and, if it is an image sequence, synchronisation signals making it possible to locate the images of the sequence.

The pixel and line synchronisation signals are applied to an orthogonal function generator 22 analogous to that used in the device shown in FIG. 2.

The marked image is applied to a module 23 receiving the orthogonal functions and extracting, pixel-by-pixel, the symbols of the message by multiplying the orthogonal functions generated by the module 22 respectively to the pixels of the image. The symbols of the message obtained are accumulated in a local accumulator 23 synchronised on the frequency of the mark produced by the extraction module 21 and receiving the parameters Lₑ and L_{b} defining the number of lines of the image to which the same permutation law and the same shuffling sequence are applied.

The line, image and mark synchronisation signals are applied to a de-shuffling and de-interleaving module 25 receiving, at the input, the shuffling sequence and the permutation law used by the device shown in FIG. 2. The module 25 and performs a reverse processing operation with respect to the one performed by modules 2, 5 and 7 of the device shown in FIG. 2, so as to obtain the bits of the word inserted in the image, which are accumulated in an accumulator 26 eventually providing the word inserted into the image.

FIG. 4 shows a device making it possible to decode a scrambled image. This device is identical to that shown in FIG. 2, except that the module 4 is removed, the module 1 is replaced by the module 21 of the device of FIG. 3, which extracts not an image synchronisation signal but a mark synchronisation signal, in order to detect, in the image, mark start and end locators, and the module 10 for transforming the image is replaced by a module 31 for extracting pixels from the image, which performs a reverse transformation with respect to the one applied by the module 10 in order to obtain the pixels of the original image.

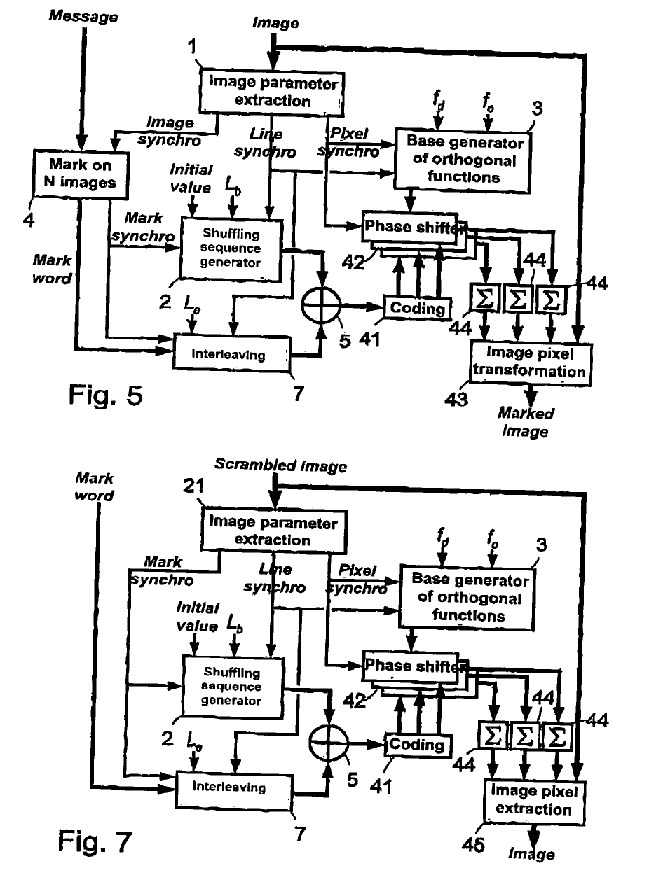

In the alternative of the insertion device shown in FIG. 5, it is possible to apply the marking signal obtained at the output of the operator 5 to a coding module 41 in order to generate a distinct marking signal for each of the colour components of the image. The marking signals obtained are applied to the input of a respective phase shifter 42 producing phase-shifted functions for each basic function and for each of the colour components of the image. These functions are then superimposed by a respective summer 44 for each colour component and applied at the input of a transformation module 43 that combines the functions respectively superimposed on the colour components of the pixels of the image.

In the application for watermark insertion, the coding performed by the module 41 is preferably chosen to introduce more redundancy between the colour components of the image, on the mark inserted in the image. This coding is thus, for example, of the ⅓ convolutional type. In the application for image scrambling, the coding performed by the module 41 is preferably chosen, by contrast, to suppress the redundancies between the marks respectively inserted in the colour components of the image.

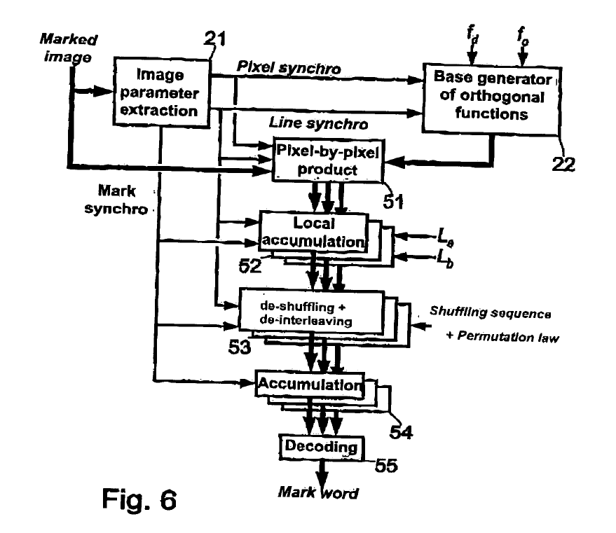

FIG. 6 shows a device for extracting a mark inserted using the device shown in FIG. 51. By comparison with the device shown in FIG. 3, this device includes a module for extracting symbols from the message, which produces message symbols for each of the colour components of the pixels of the image. This extraction device then includes a processing chain for each colour component comprising a local accumulation module 52, a de-shuffling and de-interleaving module and an accumulation module 54, these modules being identical to those of the device shown in FIG. 3. This extraction device also includes a decoding module 55, performing a reverse function with respect to that of module 41, so as to restore the mark word from the mark words accumulated for each colour component by the accumulation modules 54. If the coding applied by the coding module 41 is of the ⅓ convolutional type, the decoder 55 can be, for example, of the Viterbi decoder type.

FIG. 7 shows a device making it possible to decode a scrambled image using the insertion device shown in FIG. 5. This device is analogous to that shown in FIG. 4 and has the same modifications as those performed on the device shown in FIG. 2 in order to obtain the device of FIG. 5. In addition, the module 31 for extracting pixels from the image of the device of FIG. 4 is replaced by an extraction module 45 that extracts, from the scrambled image, the superimposed functions obtained by the summers 44 respectively for the colour components.

1-18. (canceled)

19. Method for inserting data, including a predetermined number of symbols, into an image sequence of at least one image comprising a predetermined number of lines each containing a predetermined number of pixels, said method comprising the steps of:
generating a set of functions with a comb-shaped spectrum inserted in an image sequence spectrum, and including a respective function for each symbol of the information to be inserted,
phase shifting each function of the set of functions by a value representing a respective symbol of the data to be inserted,
superimposing the phase-shifted functions, and
combining the pixels of the image sequence with a result obtained by superimposing phase-shifted functions.

20. Method according to claim 19, characterised in that, prior to the phase shifting of each function of the set of functions, the method also includes a step of interleaving the data symbols to be inserted.

21. Method according to claim 19, wherein prior to the phase shifting of each function of the set of functions, the method includes steps of generating a pseudo-random sequence including a respective symbol for each data symbol to be inserted, and of shuffling data symbols to be inserted with the pseudo-random sequence.

22. Method according to claim 21, wherein the shuffling step consists of combining, in an exclusive OR operation, data symbols to be inserted and the pseudo-random sequence.

23. Method according to claim 19, further comprising providing the functions of the function set with respective main spectral lines spaced apart by a constant step corresponding to a line frequency of the image sequence.

24. Method according to claim 19, further comprising providing the image sequence with a comb-shaped spectrum, and phase shifting the comb-shaped spectrum of the function set with respect to the spectrum of the image sequence of a frequency (f_{d}) that is adjusted.

25. Method according to claim 19, further comprising performing the combination of pixels of the image sequence with the result of the superimposing of the phase-shifted functions by modulating brightness of the pixels of the image sequence.

26. Method according to claim 19, further comprising performing the combination of the pixels of the image sequence with the result of the superimposing of the phase-shifted functions by rotating colour components of the pixels of the image sequence.

27. Method according to claim 19, further comprising the step of pre-processing the at least one image so as to avoid saturation phenomena in the pixels of the image sequence when the pixels are combined with the result of the superimposing of phase-shifted functions.

28. Method according to claim 26, further comprising a step of coding data symbols to be inserted, so as to obtain a sequence of distinct symbols for each colour component of the pixels of the image sequence, and phase shifting the functions of the function set by each sequence of the symbols obtained, superimposed, and then combined respectively with the colour components of the pixels of the image sequence.

29. Method according to claim 28, wherein the coding step comprises applying a convolutional-type coding to the data symbols to be inserted, in order to obtain a distinct symbol sequence for each colour component.

30. Method according to claims 19, further comprising performing the combination of pixels of the image sequence with the result of the superimposing of the phase-shifted functions so as to be relatively invisible in the image sequence.

31. Method according to claim 19, further comprising performing the combination of pixels of the image sequence with the result of the superimposing of the phase-shifted functions so as to scramble the images in the image sequence.

32. Method for extracting data from an image sequence of at least one image comprising a predetermined number of lines each containing a predetermined number of pixels, comprising inserting the data using an insertion method according to claim 19.

33. Method for descrambling an image sequence of at least one image comprising a predetermined number of lines each containing a predetermined number of pixels, comprising scrambling the image sequence using an insertion method according to claim 19.

34. Device for inserting data including a predetermined number of symbols, in an image sequence of at least one image comprising a predetermined number of lines each containing a predetermined number of pixels, wherein the device includes means for implementing the method according to claim 19.

35. Device for extracting data from an image sequence of at least one image comprising a predetermined number of lines each containing a predetermined number of pixels, wherein the device means for implementing the method according to claim 32.

36. Device for descrambling an image sequence of at least one image comprising a predetermined number of lines each containing a predetermined number of pixels, wherein the device includes means for implementing the method according to claim 33.
